(19) United States
(12) Patent Application Publication
(10) Pub. No.: US 2016/0121772 A1
(43) Pub. Date: May 5, 2016

(54) COLLAPSIBLE VEHICLE TRAY DEVICE

(71) Applicant: Malgorzata Stecko, Palatine, IL (US)

(72) Inventor: Malgorzata Stecko, Palatine, IL (US)

(21) Appl. No.: 14/532,758

(22) Filed: Nov. 4, 2014

(51) Int. Cl. B60N 3/00; B60N 3/10; B60R 7/04

(52) U.S. Cl. CPC B60N 3/004; B60R 7/04; B60N 3/102; B60N 3/103

(57) ABSTRACT

A collapsible vehicle tray device provides a surface in a vehicle to facilitate supporting items in an accessible position in a rear seating area of the vehicle. The device includes a front panel pivotably coupled to a back panel. The front panel is positionable parallel to the back panel defining a collapsed position. Each of a pair of side supports extends between respective lateral sides of the front panel and the back panel restricting pivoting of the front panel defining an open position. A closure coupled to the back panel is engageable to the front panel such that the front panel is held in the collapsed position. A loop extends from a distal side of the back panel relative to the front panel for hanging the back panel from a seat in a vehicle by inserting a headrest of the seat through the loop.

### BACKGROUND OF THE DISCLOSURE

### Field of the Disclosure

The disclosure relates to tray devices and more particularly pertains to a new tray device for providing a surface in a vehicle to facilitate supporting items in an accessible position in a rear seating area of a vehicle.

### SUMMARY OF THE DISCLOSURE

An embodiment of the disclosure meets the needs presented above by generally comprising a back panel and a front panel. The front panel is pivotably coupled to the back panel. The front panel is positionable substantially parallel to the back panel defining a collapsed position. Each of a pair of side supports is coupled to and extends between respective lateral sides of the front panel and the back panel. The side supports restrict pivoting of the front panel beyond a right angle relative to the back panel defining an open position. A closure coupled to the back panel is engageable to the front panel such that the front panel is held in the collapsed position. A loop extends from a distal side of the back panel relative to the front panel for hanging the back panel from a seat in a vehicle by inserting a headrest of the seat through the loop.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a collapsible vehicle tray device according to an embodiment of the disclosure.

FIG. 2 is a back view of an embodiment of the disclosure.

FIG. 3 is a side view of an embodiment of the disclosure in a collapsed position.

FIG. 4 is a side view of an embodiment of the disclosure in an open position.

FIG. 5 is a front view of an embodiment of the disclosure in use.

### DESCRIPTION OF THE PREFERRED EMBODIMENT

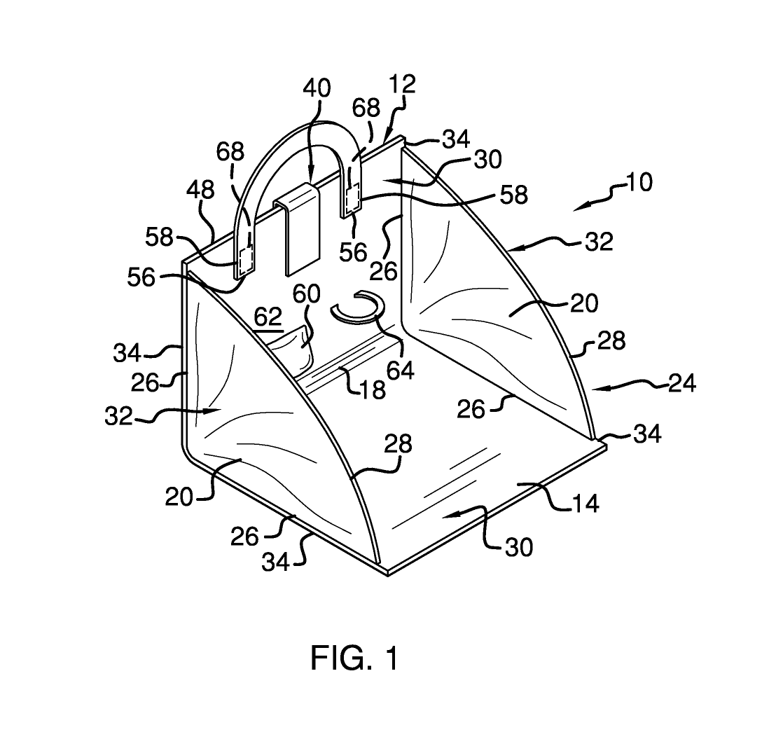

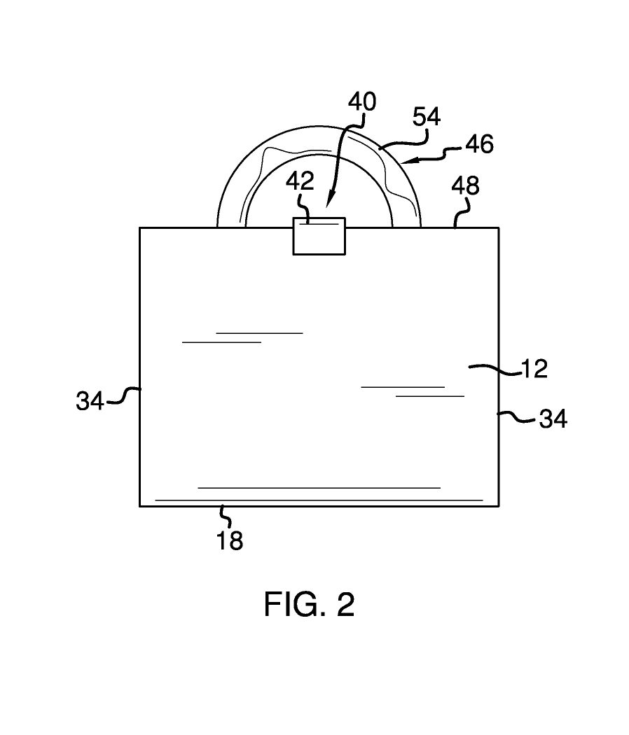

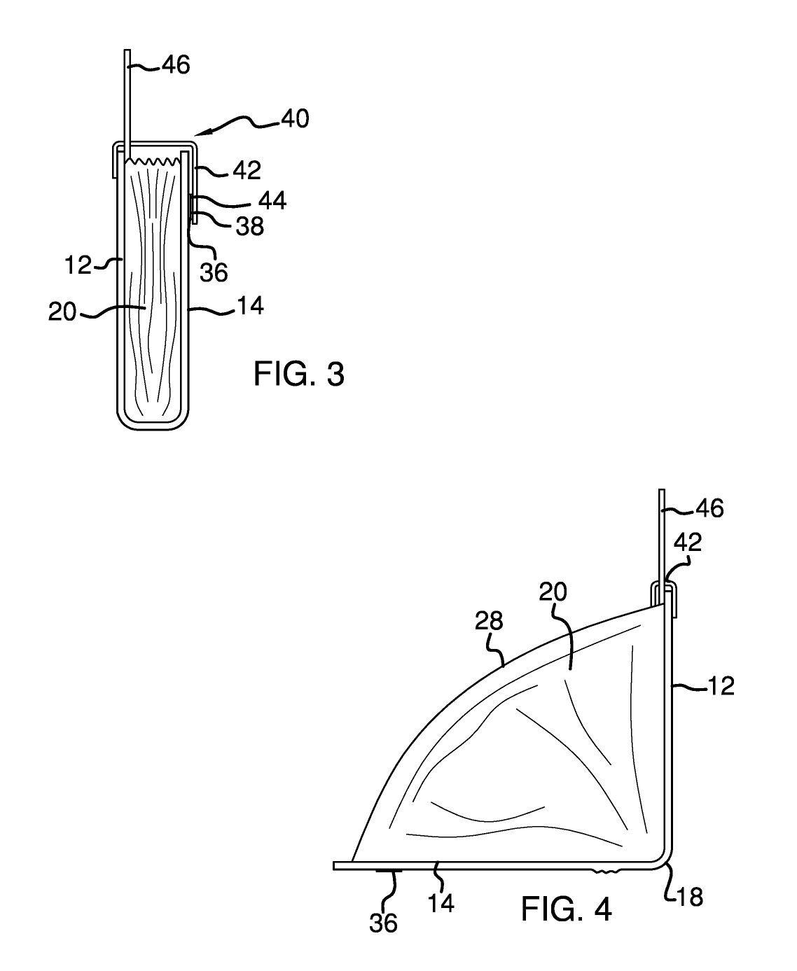

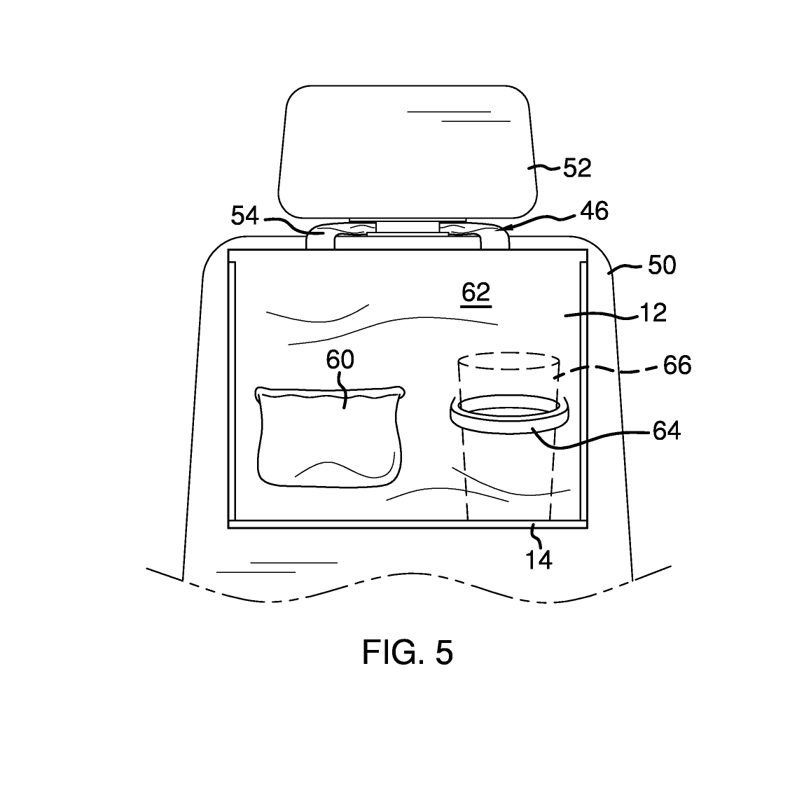

With reference now to the drawings, and in particular to FIGS. 1 through 5 thereof, a new tray device embodying the principles and concepts of an embodiment of the disclosure and generally designated by the reference numeral 10 will be described.

As best illustrated in FIGS. 1 through 5, the collapsible vehicle tray device 10 generally comprises an back panel 12 and a front panel 14. Each of the back panel 12 and the front panel 14 is stiff sufficient to retain a planar shape during use. The front panel 14 is pivotably coupled to the back panel 12 wherein the front panel 14 is pivotable relative to the back panel 12. The front panel 14 is positionable substantially parallel to the back panel 12 defining a collapsed position 16. The front panel 14 may be coupled to the back panel 12 by a living hinge 18.

Each of a pair of side supports 20 is coupled to and extends between respective lateral sides 22 of the front panel 14 and the back panel 12. The side supports 20 restrict pivoting of the front panel 14 beyond a right angle relative to the back panel 12 defining an open position 24. Each of the side supports 20 has a pair of coupled edges 26 and a single free edge 28 extending between the back panel 12 and the front panel 14. The free edge 28 of each side support 20 is arcuate and convex relative to the back panel 12 and the front panel 14. Each coupled edge 26 is coupled to a respective interior face 30 of the back panel 12 and the front panel 14 such that a respective outer face 32 of each side support 20 is coplanar with respective lateral edges 34 of the back panel 12 and the front panel 14 when in the open position 24.

A closure 40 is coupled to the back panel 12. The closure 40 is engageable to the front panel 14 such that the front panel 14 is held in the collapsed position 16. A first portion of hook and loop fastener 36 is positioned on an outer face 38 of the front panel 14 relative to the back panel 12. The closure 40 is a strap 42 having a complementary portion of hook and loop fastener 44 thereon wherein the strap 42 is removably couplable to the front panel 14 such that the front panel 14 is securable in the collapsed position 16.

A loop 46 extends from a distal side 48 of the back panel 12 relative to the front panel 14 wherein the loop 46 is configured for hanging the back panel 12 from a seat 50 in a vehicle by inserting a headrest 52 of the seat 50 through the loop 46. The loop 46 is defined by a band 54 having opposed ends 56 coupled to the back panel 12 such that the band 54 extends from the distal side 48 of the back panel 12. The band 54 may have end portions 58 coupled to the interior face 30 of the back panel 12. The band 54 may be attached using complementary portions of hook and loop fastener 68 to allow for height adjustment and connection to other areas such as coupling to a steering wheel of the vehicle.

A pocket 60 is coupled to the back panel 12. The pocket 60 is positioned on a surface 62 of the back panel 12 facing the front panel 14 when the front panel 14 is in the collapsed position 16. A ring 64 is coupled to the back panel 12. The ring 64 extends from the surface 62 of the back panel 12 facing the front panel 14 when the front panel 14 is in the collapsed position 16. The ring 64 is positioned in spaced relationship to the front panel 14 wherein the ring 64 is configured for restricting lateral movement of a beverage container 66 inserted through the ring 64 and supported on the interior face 30 of the front panel 14.

In use, the loop 46 is positioned over the headrest 52 of the seat 50 allowing the back panel 12 to hang on the seat 50. The closure 40 is disengaged to allow the front panel 14 to pivot away from the back panel 12 into the open position 24. The device 10 may then be used to support items within the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A collapsible vehicle tray device comprising:
a back panel;
a front panel, said front panel being pivotably coupled to said back panel wherein said front panel is pivotable relative to said back panel, said front panel being positionable substantially parallel to said back panel defining a collapsed position;
a pair of side supports, each of said side supports being coupled to and extending between respective lateral sides of said front panel and said back panel, said side supports restricting pivoting of said front panel beyond a right angle relative to said back panel defining an open position;
a closure coupled to said back panel, said closure being engageable to said front panel such that said front panel is held in said collapsed position;
a loop extending from a distal side of said back panel relative to said front panel wherein said loop is configured for hanging said back panel from a seat in a vehicle by inserting a headrest of the seat through said loop; and
a ring coupled to said back panel, said ring having laterally spaced opposite ends coupled to said back panel, said ring being substantially planar such that said ring is positionable to lie flat against a surface of said back panel, said ring extending from a surface of said back panel facing said front panel when said front panel is in said collapsed position.

2. The device of claim 1, further comprising a pocket coupled to said back panel, said pocket being positioned on a surface of said back panel facing said front panel when said front panel is in said collapsed position.

3. (canceled)

4. The device of claim 1, further comprising said ring being positioned in spaced relationship to said front panel wherein said ring is configured for restricting lateral movement of a beverage container inserted through said ring and supported on said front panel.

5. The device of claim 1, further comprising:
a portion of hook and loop fastener being positioned on an outer face of said front panel relative to said back panel; and
said closure being a strap having a complementary portion of hook and loop fastener thereon wherein said strap is removably couplable to said front panel such that said front panel is securable in said collapsed position.

6. The device of claim 1, further comprising said loop being defined by a band having opposed ends coupled to and extending from said distal side of said back panel.

7. The device of claim 1, further comprising each of said side supports having a pair of coupled edges and a single free edge extending between said back panel and said front panel.

8. The device of claim 7, further comprising said free edge of each said side support being arcuate.

9. The device of claim 8, further comprising said free edge of each said side support being convex relative to said back panel and said front panel.

10. The device of claim 7, further comprising each said coupled edge being coupled to a respective face of said back panel and said front panel wherein a respective outer face of each said side support is coplanar with respective lateral edges of said back panel and said front panel when in said open position.

11. The device of claim 1, further comprising said front panel being coupled to said back panel by a living hinge.

12. A collapsible vehicle tray device comprising:
an back panel;
a front panel, said front panel being pivotably coupled to said back panel wherein said front panel is pivotable relative to said back panel, said front panel being positionable substantially parallel to said back panel defining a collapsed position, said front panel being coupled to said back panel by a living hinge;
a pair of side supports, each of said side supports being coupled to and extending between respective lateral sides of said front panel and said back panel, said side supports restricting pivoting of said front panel beyond a right angle relative to said back panel defining an open position, each of said side supports having a pair of coupled edges and a single free edge extending between said back panel and said front panel, said free edge of each said side support being arcuate, said free edge of each said side support being convex relative to said back panel and said front panel, each said coupled edge being coupled to a respective face of said back panel and said front panel wherein a respective outer face of each said side support is coplanar with respective lateral edges of said back panel and said front panel when in said open position;
a portion of hook and loop fastener being positioned on an outer face of said front panel relative to said back panel;
a closure coupled to said back panel, said closure being engageable to said front panel such that said front panel is held in said collapsed position, said closure being a strap having a complementary portion of hook and loop fastener thereon wherein said strap is removably couplable to said front panel such that said front panel is securable in said collapsed position;
a loop extending from a distal side of said back panel relative to said front panel wherein said loop is configured for hanging said back panel from a seat in a vehicle by inserting a headrest of the seat through said loop, said loop being defined by a band having opposed ends coupled to and extending from said distal side of said back panel;
a pocket coupled to said back panel, said pocket being positioned on a surface of said back panel facing said front panel when said front panel is in said collapsed position; and
a ring coupled to said back panel, said ring having laterally spaced opposite ends coupled to said back panel, said ring being substantially planar such that said ring is positionable to lie flat against a surface of said back panel, said ring extending from said surface of said back panel facing said front panel when said front panel is in said collapsed position, said ring being positioned in spaced relationship to said front panel wherein said ring is configured for restricting lateral movement of a beverage container inserted through said ring and supported on said front panel.
